(19) United States
(12) Patent Application Publication
(10) Pub. No.: US 2024/0407587 A1
(43) Pub. Date: Dec. 12, 2024

(54) Method and Device for Selectively Producing Beverages or Foamed Beverages

(71) Applicant: STEINER AG WEGGIS, Weggis (CH)

(72) Inventor: Adrian Steier, Zurich (CH)

(73) Assignee: STEINER AG WEGGIS, Weggis (CH)

(21) Appl. No.: 18/700,747

(22) PCT Filed: Oct. 5, 2022
(86) PCT No.: PCT/EP2022/077695

§ 371 Date: Apr. 12, 2024

(30) Foreign Application Priority Data
Oct. 14, 2021 (CH) CH070395/21

(51) Int. Cl. A47J 31/40; A47J 31/44; A47J 31/46; A47J 31/52; A47J 31/54

(52) U.S. Cl. CPC A47J 31/401; A47J 31/404; A47J 31/4485; A47J 31/461; A47J 31/469; A47J 31/5255; A47J 31/54

(57) ABSTRACT

The invention relates to a method for selectively producing beverages or foamed beverages, preferably foamed milk, in which method the beverage is mixed by at least one powder mixing unit (2) which can be connected to at least one powder container (30; 31) for supplying instant powder and to at least one water supply (21). The mixed beverage is at least processed by a foamer unit (5) to form a beverage foam and conveyed in a cold or hot state to an outlet (6). This means that even with a mixture of powder and water, both hot and cold milk foam having an excellent foam quality in terms of consistency and healthiness can be produced.

The invention relates to a method and device for selectively producing beverages or foamed beverages, in particular from instant powder, in accordance with the preambles to claim 1 and claim 4 respectively.

Known devices for selectively producing beverages or foamed beverages each comprise a powder mixing unit, with which the beverage can be mixed from water and an instant powder. At least one water supply is provided, with which hot water can be conveyed to the powder mixing unit, and at least one powder container is provided, from which instant powder can be conveyed to the powder mixing unit.

According to the printed publication EP 1 593 330, a device and method are known for producing foamed milk or a milk beverage, wherein milk is conveyed by means of a pump from a container by way of an instantaneous water heater and via a choke point to an outlet, wherein a gas can be mixed into the milk in a regulatable quantity. In this situation, the hot foamed milk or the hot milk are conveyed by the same pump. As a result, in particular, fresh milk from a milk container can be processed to form foamed milk.

Disclosed in the printed publication EP 1 859 715 is a device for the independent dissolving of instant powder, in particular milk powder, in hot water and then foaming. In this situation, a foaming chamber is provided, which comprises a nozzle which is in connection with a hot-water pressure line, through which the water enters the foaming chamber tangentially. The latter is provided with a powder inlet opening, into which an inlet funnel opens, and with an outlet opening in the base. As a result, powder is mixed with water in this foaming chamber, and a foaming of the mixture takes place at the same time. There are the disadvantages, however, that the mixture may not be mixed sufficiently homogeneously, or that during the foaming a uniform and consistent foam can only be obtained with difficulty, as well as the fact that only hot milk foam can be produced.

The invention is based on the object of providing a method and a device of the type described heretofore, wherein the said disadvantages can be avoided and an optimum milk foam can be produced from powder in both the hot and cold state.

This object is solved according to the invention by the features of claim 1 and claim 4 respectively. Further embodiments of the method and device are defined by the features of the further claims.

With the method according to the invention for selectively producing beverages or foamed beverages, the mixed beverage is processed by at least one foamer unit to form a foamed beverage, and conveyed in a cold or hot state to an outlet.

This makes it possible that with a mixture of powder and water it is also possible for hot as well as cold foamed milk to be produced with excellent foam quality with regard to its consistency and wholesomeness.

According to the invention, the mixed beverage can be conveyed through a separate line to a mixed beverage, such as a milk or chocolate beverage, without foaming, in a hot or cold state, to the outlet. As a result, in a simple manner, a beverage can be produced from instant powder as cold or hot.

With one preferred embodiment, an instantaneous water heater is provided upstream of the at least one water supply, by means of which water temperatures can be produced with selectively adjustable values of up to 95 degrees Celsius. The instantaneous water heater is configured in such a way that it cools rapidly when it is switched off, as a result of which it is possible, at short intervals of time, to deliver cold or hot water to the powder mixing unit. For cold water delivery, however, it is also possible for a separate valve-controlled delivery line to the mixer to be provided.

Preferably, at least two separate or subdivided powder containers to be provided, such that different instant powders can be conveyed, such as milk, milk substitute, chocolate, or similar instant powders, or a powder mixture can be involved.

The invention makes provision for at least one spindle or screw conveyor to be rotatably mounted in the powder container, for conveying the instant powder, and for this to be adjustable in its speed of rotation. A flowmeter is provided in the at least one water supply, by means of the measured values from which the speed of rotation of the spindles can be adjusted. For example, for the production of hot beverages or hot foamed beverages, the water supply is lower, as a result of which a smaller amount of instant powder is added.

Coming from the powder mixing unit is in each case a first and a second separate parallel suction line, each provided with a pump, which lead to the at least one outlet. Through one suction line a mixed beverage, such as chocolate, which is not foamed, is conveyed in the cold or hot state, while the beverage which is to be foamed can be conveyed through the parallel suction line to the at least one outlet.

To the purpose, the first and the second suction lines are connected to a common central suction line, coming from the powder mixing unit.

In one embodiment, the foamer unit comprises an air intake with a flow control valve, a pump, and at least one choke point, wherein this at least one choke point serves as a foaming aid. For example, such a choke point is configured as a foaming nozzle.

The invention, and its further advantages, are described in greater detail hereinafter, on the basis of exemplary embodiments and making reference to the drawings. The Figures show:

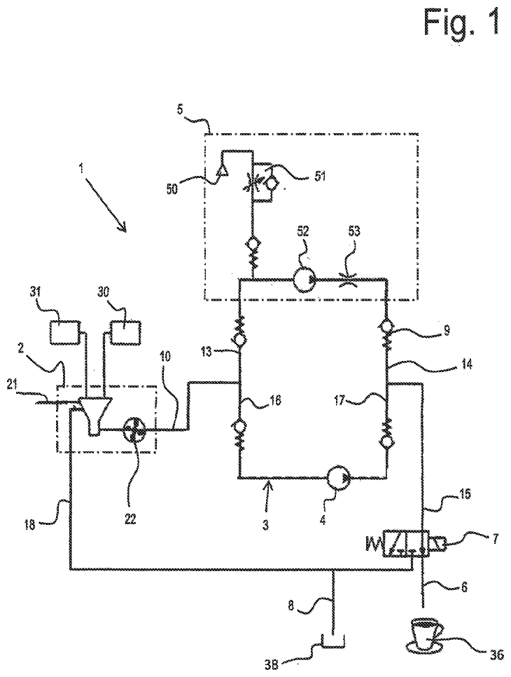

FIG. 1 is a hydraulic schematic of a device according to the invention for selectively producing beverages or foamed beverages;

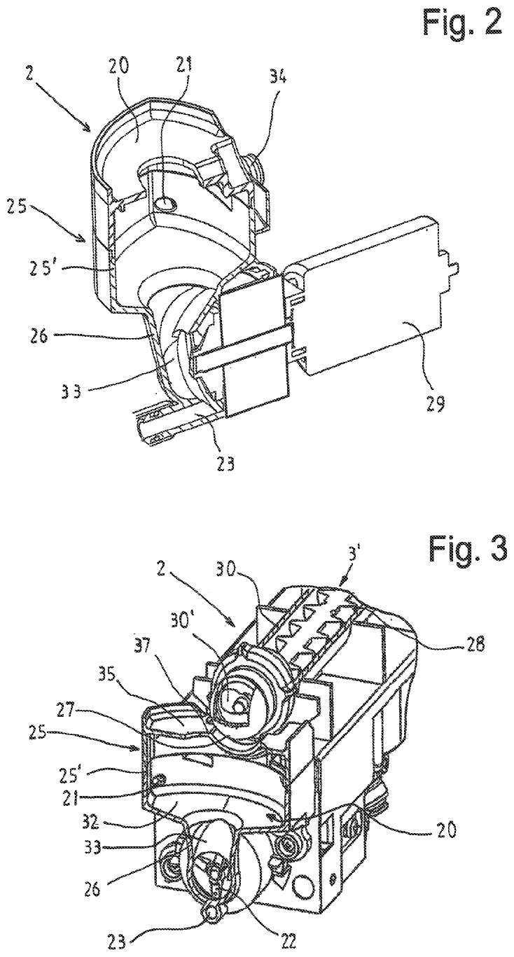

FIG. 2 is a perspective longitudinal section of the funnel housing of a powder mixing unit according to FIG. 1;

FIG. 3 is a perspective front view with a section through the funnel housing or a powder container of the powder mixing unit according to FIG. 2; and

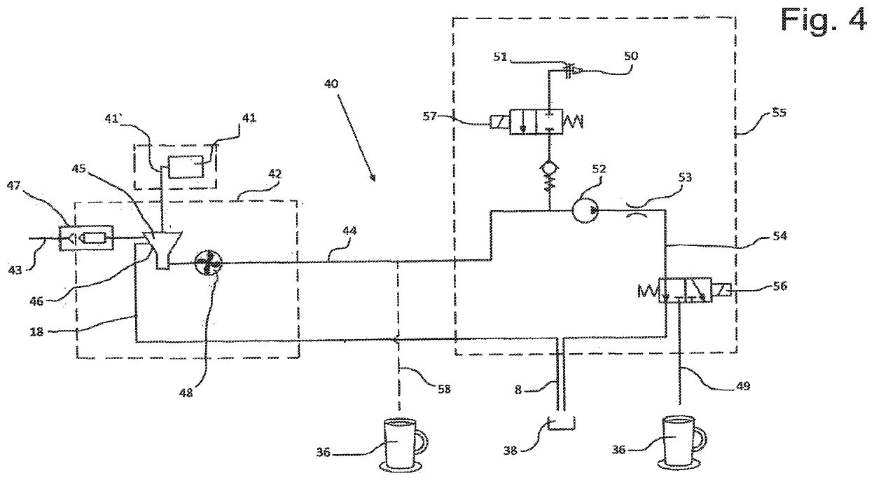

FIG. 4 is a hydraulic schematic of a variant of a device according to the invention for selectively producing beverages or foamed beverages.

FIG. 1 shows a schematic representation of a device 1 for selectively producing beverages or foamed beverages, wherein the particular purpose is to produce, instead of beverages from natural milk, such beverages from powder. As the powders, use is usually made of what is referred to as water-soluble instant powders, which are produced in a conventional manner. This involves milk, milk substitute, chocolate, or similar instant powders. It is also possible, however, for powder mixtures of milk and chocolate or other powders to be used, with flavouring agents such as vanilla, sugar, coffee, caramel, cocoanut, fruits, etc. It is not restricted to specific types of powder. The powder can consist of material in the form of flour and/or grains of sand.

This device 1 comprises a powder mixing unit 2 with a powder feed and a water delivery element 21. From a first powder container 30, a first instant powder, and/or from a second powder container 31 a second instant powder, are in each case conveyed in a dosed or metered manner into a mixing chamber 20, and are mixed in this with the water to form a homogenous mixture without powder residues.

According to the invention, the mixed beverage is processed by at least one foamer unit 5 to form a beverage foam, and is conveyed in a cold or hot state to an outlet 6. To the purpose, either cold or hot water is conveyed through the at least one water supply 21 into the powder mixing unit 2, from which the mixed beverage can be conveyed through a foamer unit 5 in order to produce cold or hot beverage foam, and from this to the outlet 6.

This therefore makes it possible, with a mixture of powder and water, for both hot and cold milk foam to be produced, with excellent foam quality with regard to its consistency and wholesomeness.

The foamer unit 5 is characterized by a simple structural design, which is provided with an air intake 50 with a flow control valve 51, a pump 52, and at least one choke point 53, in an outlet line 14, 15 leading to the outlet 6, as the first conveying line. The beverage mixture which is suctioned up by the powder mixing unit 2 is intermixed at the air intake 50 with a specific amount of air, and processed by the pump 52, the choke point 53 and the outlet line 14, 15 to form foamed milk, and at the outlet 6 is filled into a cup 36, a pot, or the like. Advantageously, arranged at the outlet 6 is a further outlet, not shown, in particular for coffee, such that different beverage variants can be selected, preferably Cappuccino, Latte Macchiato or other beverage types.

Within the framework of the invention, provision is also made for a second line 3 coming from the powder mixing unit 2, with a suction line 16, a pump 4, and an outlet line 17, which likewise leads via a T-piece to the at least one outlet 6. Through this line 3, running parallel to the lines 13, 14 of the foamer, a mixed beverage is conveyed, such as a chocolate beverage. Accordingly, this line 3 allows for the conveying of a mixed beverage prepared in the powder mixing unit 2, again in the cold or hot state, directly to the outlet 6, without this being foamed.

The mixed beverage can be conveyed away via a central suction line 10 out of the powder mixing unit 2. The central suction line 10 opens via a T-piece into these first and second suction lines 13, 16 and from these, by means of the respective pump 52, 4, leads onwards into these first and second outlet lines 14, 17 respectively, and consequently into a central outlet line 15 with an actuation valve 7, to the outlet 6.

Preferably, at the foamer unit a tried and trusted gear pump is used, and at the line 3 a peristaltic pump or hose pump is used. Instead of these, however, it would also be possible, if required, for other conveying drive units to be used.

Arranged in the circuit between the central suction line 10 and the outlet line 15 respectively, and the foamer unit 5 and the first pump 4 respectively, is in each case a non-return valve 9. This non-return valve 9 ensures that the beverage is guided from the suction line 10 either via the foamer unit 5 or the line 3 to the outlet line 15. Depending on which pump 52 or 4 are engaged in the circuit, the beverage is suctioned from the powder mixing unit 2 via the one or the other suction line 13, 16, and conveyed through the foamer unit 5 or the line 3 to the outlet 6.

Moreover, overflow lines 18 lead from the powder mixing unit 2 and from the actuation valve 7 at the outlet 6 to a runoff 8, arranged beneath which is a catchment container 38. By means of these overflow lines 18 a flushing procedure can be carried out, which is not described in greater detail.

The powder mixing unit 2 according to FIG. 2 and FIG. 3 is composed of a powder container 30 as indicated, with a powder delivery element 3′, a funnel housing 25 with a mixing chamber 20, a water connection 34 with a water supply 21, an outlet channel 26 with a mixing wheel 22 therein, and a beverage outlet 23. In the powder container 30, configured as longitudinal, the powder delivery element 3′ is formed by a screw conveyor 28 or the like, mounted such as to be rotatable horizontally in the lower region along its longitudinal extension, arranged at which is a face-side opening 30′ in the powder container 30, connected to which is an outlet element 27, which on the upper side leads into the mixing chamber 20 of the funnel housing 25, and directs the powder into approximately the middle region of this mixing chamber. This powder delivery element 3′ in the powder container 30 could also be configured differently, such as a flap, wherein the powder could only be delivered in a metered or dosed manner by its being opened. The mixing chamber with the powder and water delivery could also be configured differently, for example by the powder likewise being conveyed laterally into the mixing chamber.

The funnel housing 25 is configured with an upper approximately cylindrical section 25′ with a cover 35, comprising an opening 37, a ring-shaped base wall 32, and a lower narrower conical throughflow opening 33 in the outlet channel 26. Arranged in the latter channel is the mixing wheel 22 shown in FIG. 3, with an axis of rotation transverse to the direction of flow of the powder, by means of which the mixing chamber 20 is connected to a beverage outlet 23. The mixing wheel 22 is connected to a drive unit 29, and can be driven by this. The water supply 21 opens in a water inlet essentially tangentially inside this cylindrical section 25′ of the mixing chamber 20. The beverage outlet 23 of the powder mixing unit 20 is connected to the central suction line 10. The configuration of this funnel housing and of the mixing chamber respectively, and, as applicable, the one or more water supplies, could also be configured differently.

Integrated into the at least one water supply 21, or downstream of the powder mixing unit 2, is a flowmeter, not shown in any greater detail, of which the measured values are detected and evaluated by a control device. In addition, the speed of rotation of the screw conveyor 28 in the powder container 30, which can be rotated by a rotary drive, can also be adjusted by the control device. For example, during the preparation of hot beverages or hot foamed beverages, the water supply quantity can be adjusted as lower than with cold beverages, as a result of which a lesser amount of instant powder is also conveyed. It would likewise be possible, however, for another form of control to be used, wherein the water delivery quantity and/or the speed of rotation of the screw conveyor 28 could also be varied in a controlled manner.

Advantageously, provided upstream of the powder mixing unit 2 is an instantaneous water heater, not shown in any greater detail, which can be switched on or off depending on whether hot or cold water is being conveyed. With this instantaneous water heater, the water temperature can be selected and adjusted as desired between room temperature and approx. 95° C. It is also possible for a second separate water supply to be provided for the cold water, which can be switched on and is not conveyed to the instantaneous water heater, but directly into the powder mixing unit 2.

In principle, the instantaneous water heater could be arranged downstream of the pumps 4, 52 at the outlet line 15, and the powder mixing unit 2 could be provided with cold water only. Instead of an instantaneous water heater, it would also be possible for another heating means to be used, such as a boiler or the like, from which the hot water could be drawn.

FIG. 4 shows a device 40 with a powder mixing unit 42 and, connected to this by a line 44, a foamer unit 55. This powder mixing unit 42 comprises a powder delivery element 41′ from a powder container 41, a water delivery line 43 with a non-return valve 47, a funnel housing 46 with a mixing chamber 45 and a mixing wheel 48. The powder mixing unit 42 is configured in the same way as that according to FIG. 1 or FIG. 3, and therefore its details will not be explained once again hereinafter. From at least one powder container 41, an instant powder, and also cold, warm, or hot water, are introduced in a dosed or metered manner into the mixing chamber 45, are mixed there, and are then processed by the mixing wheel 48, driven by the rotary drive, to form a homogenous mixture. The mixture is then conveyed further through the line 44 into the foamer unit 50.

According to the invention, in the foamer unit 55, from the mixed beverage of powder and water in the cold or hot state, a beverage powder is produced, which is conveyed through a line 54 with a switchover valve 56, to an outlet 49 into a cup 36 or another container.

This foamer unit 55 is of similar configuration to that according to FIG. 1. Accordingly, in part the same reference numbers are used for them. An air intake 50, a pump 52, and at least choke point 53 are provided in a line 54 leading to the outlet 49. Assigned to this air intake 50 as a line are a flow regulating valve 51, a closing valve 57, and a non-return valve. With this closing valve 57 of the air inlet 50, in its closed position, it becomes possible that the flowing mixed beverage of powder and water does not foam, and is discharged as cold or hot milk, by contrast with the device 1 according to FIG. 1, where a second line 3 is provided parallel to the suction line 13. In this situation, depending on the choice of beverage, this closing valve 57 is actuated accordingly by a control unit.

The beverage mixture suctioned by the pump 52 from the powder mixing unit 42 is mixed at the air inlet 50 with a specific quantity of air, and processed to foamed milk by the pump 52, the choke point 53, and the line 54, and conveyed at the outlet 49 into the cup 36, a jug, or the like. Advantageously, a further outlet, not shown, in particular for coffee is arranged immediately next to the outlet 49, in order to produce a Cappuccino or similar in the cup.

Likewise, overflow lines 18 lead from the powder mixing unit 42 through the foamer unit 55 and from the switchover valve 56 at the outlet 49 to the runoff 8, arranged beneath which is the catchment container 38. By means of these overflow lines 18, the flushing procedure can be carried out, which is not described in greater detail.

In addition, a branch line 58 is shown from the line 44 upstream of the foamer unit 55, through which the mixed beverage can be discharged into the cup 36, and for this a closing valve, not shown in greater detail, could be provided. In this situation, the rotating mixing wheel 48 could convey the mixture produced in the powder mixing unit 42 into this branch line 58.

These devices are advantageously integrated into a coffee machine, in which a water connection is contained, and at which at least one powder container is arranged in such a way that it is accessible and can be refilled from the outside.

The invention has been adequately described by the foregoing exemplary embodiments. It could also be explained by further variants, however. For example, at the delivery of water into the mixing chamber of the powder mixing unit, a mixture of water and milk or water with additives could be used, such as emulsifiers, taste-enhancing substances, or the like.

It would also be possible for a connection to be provided to a milk container with fresh milk, wherein this milk could be conveyed directly to the foamer unit and then as foamed milk to the outlet.

It would of course also be possible for the foamer unit 5 to be configured differently. For example, the air inlet quantity could be adjusted by a manually adjustable control valve. Instead of one or two such choke points 53, at least one other foamer element having the same effect could be included in the system.

In principle, it would be possible, with the use of only one pump 52, and without this separate line 3 for a chocolate beverage or the like, for a separate line leading away from the pump, without a choke point, to lead via a switchable valve to the outlet line.

1. Method for selectively producing beverages or foamed beverages, preferably foamed milk, wherein the beverage is mixed by at least one powder mixing unit (2, 42), which can be connected to at least one powder container (30; 31, 41) for delivering instant powder, and with at least one water supply (21, 43), characterized in that the mixed beverage is processed by a foamer unit (5, 55) to form a foamed beverage, and is conveyed in a cold or hot state to an outlet (6, 49).

2. Method according to claim 1, characterized in that the mixed beverage is conveyed from the powder mixing unit (2) as a mixed beverage, such as a milk or chocolate beverage, separately without foaming, in a cold or hot state, to the outlet (6).

3. Method according to claim 1, further comprising conveying the water of the at least one water supply in a cold or hot state into the powder mixing unit.

4. Device for carrying out the method according to claim 1, wherein by means of the least one water supply, cold or hot water can be conveyed into the powder mixing unit, from which the mixed beverage can be conveyed through a foamer unit for producing cold or hot beverage foam.

5. Device according to claim 4, characterized in that the foamer unit (5, 55) is provided with an air inlet (50), a pump (52), and at least one choke point (53) in outlet line (14, 15, 54) leading to the outlet (6, 49).

6. Device according to claim 4, further comprising a line running parallel to the foamer unit, suction line connected to the powder mixing unit, a pump, and an outlet line leading to the at least one outlet, by means of which a mixed beverage, such as a milk or chocolate beverage, can be conveyed without foaming in a cold or hot state.

7. Device according to claim 4, further comprising a central suction line that leads away from the powder mixing unit, which opens into suction lines of the line or the foamer unit respectively, and from this leads into a central outlet line with an actuation valve and to the outlet.

8. Device according to claim 4, further comprising a suction line that leads from the powder mixing unit directly to the foamer unit, and from this to the outlet, wherein an actuatable closing valve is assigned to the air inlet, by means of which the air inlet can be blocked or opened, and therefore, as desired, the mixed beverage can be conveyed not foamed or foamed, cold or hot, to the outlet.

9. Device according to claim 4, wherein the powder mixing unit consists of a funnel housing with a mixing chamber, leading into which is a powder supply, at least one water supply leading essentially tangentially into the mixing chamber, an outlet channel, in which is a drivable mixing wheel, and a beverage outlet.

10. Device according to claim 9, characterized in that the funnel housing (25) is configured with an approximately cylindrical section (25′), an upper cover (35), a ring-shaped base wall (32), and a lower flow opening (33), in which this mixing wheel (22) is arranged with an axis of rotation transverse to the direction of flow, wherein an outlet element (27) leads from the powder container (30) into the mixing chamber (20).

11. Device according to claim 4, wherein the powder container is equipped with a powder delivery element, which is formed by a screw conveyor in the lower region of the powder container mounted such as to rotate horizontally along its longitudinal extension, through which, on the front side, the powder can be conveyed at an opening in the powder container, through the outlet element arranged on the upper side, into the mixing chamber.

12. Device according to claim 11, characterized in that the screw conveyor (28) can be rotated by a controllable drive unit, and, depending on the quantity of water which is detected by a flowmeter, the water supply (21) can be adjusted in its speed of rotation by means of a control unit.

13. Device according to claim 4, further comprising an instantaneous water heater upstream of the powder mixing unit at the water supply, which, depending on whether hot or cold water is being conveyed, can be switched on or off, and by means of which the water temperature can be adjusted as desired between close to room temperature and approximately 95° C.

14. Device according to claim 4, wherein as instant powder, use can be made of a milk powder, a milk substitute powder, chocolate powder, or a powder mixture with taste additives, such as vanilla, sugar, coffee, caramel, cocoanut, fruits etc.
